(19) United States
(12) Patent Application Publication
(10) Pub. No.: US 2014/0242279 A1
(43) Pub. Date: Aug. 28, 2014

(54) COATINGS FOR SURFACTANT-CONTAINING BARS

(71) Applicants: Dow Global Technologies LLC, Midland, MI (US); Rohm and Haas Company, Philadelphia, PA (US)

(72) Inventors: Nad Saugata, West Bengal (IN); Ravi Rao, Pune (IN); Robert Krasnansky, Le Rouret (FR)

(21) Appl. No.: 14/350,110

(22) PCT Filed: Oct. 16, 2012
(86) PCT No.: PCT/US2012/060373

§ 371 Date: Apr. 7, 2014

Related U.S. Application Data
(60) Provisional application No. 61/548,756, filed on Oct. 19, 2011.

(51) Int. Cl. C11D 17/00

(52) U.S. Cl. CPC C11D 17/0039; C11D 17/0047
USPC 427/331

(57) ABSTRACT

The present invention relates to coating compositions for surfactant-containing bars (e.g., soap bars and dish bars).

### FIELD

The present invention relates to coating compositions for surfactant-containing bars (e.g., soap bars and dish bars).

### BACKGROUND

Surfactant-containing bars, whether for personal care or hand dishwashing, are economical and convenient, but one severe drawback associated with soap bars is that they suffer from prolonged exposure to water. For example, the surfaces in contact with water over a period of time become saturated and swell, discolor, and lose at least some of their structural integrity (a phenomenon easily visualized by anyone who has used soap and commonly described as becoming “mushy” or exhibiting “mushiness”). Aside from being aesthetically displeasing, this is wasteful, as the mushy portion sloughs off and is often lost.

Several attempts have been made to reduce mushiness, whether by forming harder bars or coating the bars with UV-cured plastic coating. Aside from being cost intensive, UV—cured plastic coating is disadvantageously brittle and cracks, which leads to water ingression. Accordingly, what is needed are improved coatings on surfactant-containing bars.

### DETAILED DESCRIPTION

In one embodiment, the present invention provides a method for coating a water-soluble, surfactant-containing, bar, to impart water resistance to at least one surface of the bar, the method comprising applying to the bar a coating comprising a binder, and an amine functionalized monomer or low molecular weight polymer, and allowing the pH of the coating to fall below 9.6.

The term “water-soluble, surfactant-containing, bar” refers to conventional soap bars or dish bars that are to be applied by brush or hand, as opposed to automatic dishwasing sachets or the like. In one embodiment, the water-soluble, surfactant-containing, bar is a personal care soap bar. In one preferred embodiment, the water-soluble, surfactant-containing, bar is a manual dish wash bar.

The phrase “impart water resistance” is intended to convey a level of protection from water incursion sufficient to retard mushiness. In one embodiment, the coated portion is resistant to water incursion for at least 2 hours, for at least 4 hours, for at least 8 hours, for at least 12 hours, for at least 24 hours, for at least 48 hours, for at least 96 hours, for at least one week, and preferably for at least two weeks. In one embodiment, the coating is substantially insoluble in water even under alkaline conditions.

In one embodiment, the bottom (i.e., the surface in contact with, or immediately adjacent to, the substrate (sink, tub, ground and the like) that the surfactant-containing bar is resting upon) of the surfactant-containing bar is coated. In one embodiment, the bottom of the surfactant-containing bar and a lower (i.e., adjacent to the bottom) portion of the sides of the surfactant-containing bar are coated. In one embodiment, the bottom of the surfactant-containing bar and the entire sides of the surfactant-containing bar are coated. In one embodiment, the surfactant-containing bar has six surfaces (top, bottom, and four sides), and five surfaces are coated.

In one embodiment, the binder is selected from i) acrylic emulsions comprising one or more monomers selected from methyl methacrylate, butyl acrylate, methyl acrylic acid, acrylic acid, ethyl hexyl acrylate or derivatives thereof, ii) polyolefinic dispersions, iii) ethylene vinyl acetate copolymers, or iv) styrene block copolymers. In one embodiment, the binder comprises from 99.5 wt % to 30 wt %, 99.5 wt % to 70 wt %, preferably 99 wt % to 80 wt %, of the coating composition.

In a preferred embodiment, the binder is an acrylic emulsion. The acrylic emulsion can further comprise one or more additives, e.g. dodecyl mercaptan, as a chain transfer agent to control molecular weight of the polymers. A non-limiting example of an acrylic emulsion is a mixture of 51% solids (containing 67.2% methyl methacrylate, 31.5% butyl acrylate, 1.3% methacrylic acid) and 49% water.

In one embodiment, the binder is a polyolefin dispersion. The polyolefin dispersion may be selected from various grades of DPOD™ or HYPOD™ (commercially available from The Dow Chemical Company), which contains acid-modified ethylene polymer-based metallocene catalyzed polyolefin dispersion in water. Some non-limiting examples of the polyolefin dispersion grades are DPOD 8501, DPOD 8502 or DPOD 8101.

In one embodiment, the amine functionalized monomer is Diallyldimethyl Ammonium Chloride (“DADMAC”), Acryloxyethyldimethyl(benzyl) Ammonium Chloride (“ADAMQUAT”), MethacrylolAminopropyl Trimethyl Ammonium Chloride (“MAPTAC”), or Methacryloxyethyldimethyl Ammonium Chloride (“MADQUAT”). In one embodiment, the amine functionalized monomer or low molecular weight polymer is p(DMAEMA) and p(OXEMA). In one embodiment, the amine functionalized monomer or low molecular weight polymer is p(ethyleneimine) or p(vinyl amine). In one embodiment, the amine functionalized monomer or low molecular weight polymer comprises from 0.5 wt % to 3 wt %, preferably 1 wt % to 2 wt %, of the coating composition.

In one embodiment, the binder and amine functionalized monomer or low molecular weight polymer are combined sold as a pre-mix.

In one embodiment, the coating composition further comprises at least one antifoaming agent, dispersing agent, surfactant, pigment, organic solvent, or polar solvent.

Non-limiting examples of antifoaming agent include those sold under the tradenames NOPCO 8034, DEHYDRAN 1208, DEHYDRAN 1293, or DEHYDRAN 1861. A preferred antifoaming agent is NOPCO 8034 (commercially available from Henkel).

Non-limiting examples of dispersing agent include AS-238™ (commercially available from Lefrant-Rubco) and OROTAN 850ER™ (commercially available from The Dow Chemical Company).

Non-limiting examples of surfactant include non-ionic surfactants or wetting agents such as from primary or secondary fatty alcohols or Lauryl alcohol ethoxylates, for example TERGITOL™ series like TERGITOL™15-S-40, TERGITOL™15-S-7, ECOSURF™ SA-9, SA-7 (commercially available from The Dow Chemical Company).

Non-limiting examples of pigment include pigments or opacifiers such as TiO₂ (preferably TR92 (commercially available from Huntsman) or R902 (commercially available from Du Pont) or Calcium Carbonate extenders of varying particle size like Durcal-2198 & Durcal-10™ (commercially available from Omya).

Non-limiting examples of organic solvent include non-ionic wetting agents & molecular de-foamer like SURFYNOL 104E™(commercially available from Air Products), glycol ethers, such as TEXANOL (commercially available from Kraemer & Martin GmbH), DOWANOL™ (commercially available from The Dow Chemical Company), some exemplary grades are DOWNOL DPnB or DOWNOL PPH.

Non-limiting examples of polar solvents include water, methanol, ethanol.

The coating composition may be applied to the surfactant-containing bar at the time the surfactant-containing bar is being manufactured, for example, as a manufacturing step in the line, or after manufacture. In operation, the coating composition may be applied by any conventional method, such as brush coating, flow coating, immersion (dip coating), or spray coating. In preferred embodiments, the coating composition adheres to the surfactant-containing bar sufficiently to prevent delamination.

In one embodiment, the coating composition is applied to the bar at 40° C. to 80° C.

In some embodiments, the coating composition is diluted with water before application (such as 95:5, 90:10, 85:15, 80:20, 75:25, and 70:30).

While not wishing to be bound by theory, it is believed that drying/or curing of the coating composition is a result of the pH drop as the ammonium is protonated and ammonia is released. Accordingly, in one embodiment, the method further comprises the step of sequestering the volatile ammonia released from the coating composition.

In one embodiment, the method further comprises the step of maintaining the pH of the coating composition at a pH greater than 9.6 until the coating composition is applied. In one embodiment, the method further comprises the step of maintaining the coating composition under pressure until the coating is applied.

One advantage to the present invention is that the coating is not subjected to any photo-radiation, e.g. UV radiation, for its curing. This results in reduced manufacturing costs for producing a coated bar as it does not require photo-radiation set up (i.e., UV tunnels) and time associated with radiation curing.

In operation, the time required for drying/curing of the coat may vary depending on the coating composition. When an acrylic emulsion of the preferred embodiment is used, the drying time is less than 5 seconds. This is extremely advantageous, as the bar can be coated in line and forwarded for packaging immediately.

### EXAMPLES

The following examples are for illustrative purposes only and are not intended to limit the scope of the present invention. All percentages are by weight unless otherwise specified.

### Example 1

Examples of coating compositions of the present invention are listed in TABLE 1 in percent by weight:

TABLE 1

| Ingredient | Batch A | Batch B | Batch C | Batch D |
|---|---|---|---|---|
| Acrylic emulsion | 36.6 | 89.85 | 41.48 | 0 |
| DPOD 8501 | 0 | 0 | 0 | 85 |
| NOPCO-8034 ™ | 0.27 | 0.5 | 0.27 | 0 |
| DOWANOL DPM | 0 | 0 | 0 | 5 |
| TERGITOL 15-S-40 | 0.29 | 0 | 0.33 | 0 |
| NaDOBS | 0 | 0 | 0 | 1 |
| SURFONYL 104 E | 0 | 0.3 | 0 | 0 |
| AS-238 | 0.82 | 0 | 0.86 | 0 |
| Tioxide TR-92 | 9.63 | 0 | 0 | 0 |
| Green pigment paste | 0 | 0.05 | 0.05 | 0 |
| Durcal-10 | 30.4 | 0 | 34.36 | 0 |
| Durcal-2 | 15.2 | 0 | 17.18 | 0 |
| Ethanol | 1.18 | 0 | 0 | 0 |
| Texanol | 3.8 | 9.3 | 4.23 | 0 |
| Water | 1.81 | 0 | 1.2 | 9 |

At all times, a pH of 9.8 or higher is maintained (using ammonia). Components (emulsion, dispersing agent, surfactant and defoamer, and pigments are mixed at 1200-1500 rpm for 20-25 minutes (cooling the outside of the mixing vessel). The mixture is tested with a Hegman gauge before letdown (Hegman reading of above 3 is sufficient (below 60 to 70 microns)). Next are added alcohol, defoamer, coalescent (added slowly with good agitation), thickener, water, and ammonia (if needed to insure pH of 9.7).

### Example 2

To determine the efficacy of the coating compositions, manual dishwash bars were coated and tested for mush development (by conventional gravimetric analysis) upon exposure to water in a Petri dish over time, with results listed in TABLE 2

TABLE 2

| | 0.5 hr | 5 hr | 24 hr | 72 hr | 120 hr |
|---|---|---|---|---|---|
| Uncoated bar | 0.889 | 5.44 | 7.01 | 8.53 | 9.27 |
| (comparative) | | | | | |
| UV Coated Bar | 0 | 0 | 1.7 | 3.3 | 5.6 |
| (comparative) | | | | | |
| Bar coated with | 0 | 0 | 0 | 0 | 0 |
| 0.08 g/cm² coat Batch A | | | | | |
| (90:10) | | | | | |
| Bar coated with | 0 | 0 | 0 | 0 | 0 |
| 0.03 g/cm² coat Batch A | | | | | |
| (70:30) | | | | | |
| Bar coated with | 0 | 0 | 0 | 0 | 0 |
| 0.06 g/cm² coat Batch B | | | | | |
| Bar coated with | 0 | 0 | 0 | 0 | 0 |
| 0.03 g/cm² coat Batch C | | | | | |
| (90:10) | | | | | |
| Bar coated with | 0 | 1.55 | — | — | — |
| 0.04 g/cm² coat Batch D | | | | | |

### Batch A

Batch A thicker coat: Dilute the coating composition of Example 1 with de-ionized water in the ratio 90 (coating composition): 10 (water). Heat the dish-washing bar to about 80 deg C to obtain surface temperature of the bar about 65 deg C. Apply the diluted coating composition to 5 of the 6 faces by brush. Allow the bar to cool at room temperature while the applied coat dries (takes 3-5 seconds).

Batch A thinner coat: As above, but apply using a spray gun with nozzle diameter of about 1 mm.

Batch B: As above, undiluted and applied with a spray gun.

Batch C: As above, a 90:10 dilution ratio, and applied with a spray gun.

Batch D: As above, apply DPOD 8501™(a HYPOD solution) to 5 of the 6 faces of the pre-heated bar with a brush. Allow the coating to dry in the oven at about 80 deg C for 60 minutes.

The coatings of the present invention show good adhesion/binding to the bar surface, and thus do not get peeled off from the bar while in use or storage. Various coating compositions provide water resistance for more than 3 days, preferred coating compositions comprising acrylic emulsions show stability more than 7 days.

1. A method for coating a water-soluble, surfactant-containing, bar, to impart water resistance to at least one surface of the bar, the method comprising:
applying to the bar a coating composition comprising:
a binder, and
an amine functionalized monomer or low molecular weight polymer; and allowing the pH of the coating to fall below 9.6.

2. The method of claim 1, wherein the coating composition is applied to the bar at 40° C. to 80 ° C.

3. The method of claim 1, wherein the binder is selected from i) acrylic emulsions comprising one or more monomers selected from methyl methacrylate, butyl acrylate, methyl acrylic acid, acrylic acid, ethyl hexyl acrylate or derivatives thereof, ii) polyolefinic dispersions, iii) ethylene vinyl acetate copolymers, or iv) styrene block copolymers.

4. The method of claim 1, wherein the amine functionalized monomer is Diallyldimethyl Ammonium Chloride (“DADMAC”), Acryloxyethyldimethyl(benzyl) Ammonium Chloride (“ADAMQUAT”), MethacrylolAminopropyl Trimethyl Ammonium Chloride (“MAPTAC”), or Methacryloxyethyldimethyl Ammonium Chloride (“MADQUAT”).

5. The method of claim 1, wherein the low molecular weight polymer is p(DMAEMA), p(OXEMA), p(ethyleneimine), or p(vinyl amine).

6. The method of claim 1, wherein the coating composition further comprises at least one antifoaming agent, dispersing agent, surfactant, pigment, organic solvent, or polar solvent.

7. The method of claim 1, further comprising the step of sequestering the volatile ammonia released from the coating composition.

8. The method of claim 1, further comprising the step of maintaining the pH of the coating composition at a pH greater than 9.6 until the coating composition is applied.

9. The method of claim 1, further comprising the step of maintaining the coating composition under pressure until the coating composition is applied.

10. The method of claim 1, wherein the water-soluble, surfactant-containing, bar is a manual dish wash bar.

11. The method of claim 1, wherein the water-soluble, surfactant-containing, bar is a personal care soap bar.
